(19) United States
(12) Patent Application Publication
(10) Pub. No.: US 2019/0160384 A1
(43) Pub. Date: May 30, 2019

(54) Mathematical Learning Device and Method

(71) Applicant: Mark Harold Niemi, Saskatoon (CA)

(72) Inventor: Mark Harold Niemi, Saskatoon (CA)

(21) Appl. No.: 15/826,429

(22) Filed: Nov. 29, 2017

(51) Int. Cl. A63F 13/80; A63F 13/21; A63F 13/25; A63F 13/335

(52) U.S. Cl. CPC A63F 13/80; A63F 13/335; A63F 13/25; A63F 13/21

(57) ABSTRACT

A mathematical learning device and method comprising a plurality of puzzle grids (60), each of which displays four digits (12) in a grid pattern of two rows and two columns. These four digits (12) are in a relationship to one another predetermined according to a rule defined mathematically and logically. Each puzzle grid (60) also has its own solution grid (70) not displayed with the same puzzle grid (60), in which solution grid (70) valid substitute values (42), according to the same rule, for each of one of the four digits (12) of the puzzle grid (60), or any multiplier (22, 32) defined in the predetermined rule, are shown as a solution to this same puzzle grid (60).

### FIELD OF THE INVENTION

This invention is in the field of learning devices, and more specifically to mathematical learning devices.

### BACKGROUND

One of the most important skills in mathematics is the ability to manipulate mathematical symbols effectively. Indeed, this is one skill that is considered prerequisite to learning advanced mathematical concepts (for example, finding unknown quantities in algebra or deductively proving theorems from axioms). Early on and at an elementary level, mathematical symbolism is encountered by the student in the form of positional notation, otherwise known as place value notation. In place value notation the same digit can have different meanings depending on its position when representing a multi-digit number.

Many mathematical learning devices up to now have focused only on helping students conceptualize mathematical concepts and their symbolism, especially that of number, in a concrete way. In many cases these devices have taken the form of digits relating to objects scaled to size, in order to show the relative sizes of quantities to one another and hence provide a picture of what the digits represent. All such devices give the student concrete representations of number, so that they can more readily understand the concept of number, whether small or large. This often coincides with a teaching of positional notation, also pictured in a concrete way.

Similar devices to these have focused instead on mathematical operations such as addition or multiplication. Here too the emphasis has been on illustrating the concept of a mathematical operation by concrete aids, especially visual aids or pictures. Arrays of objects forming spatial patterns are often used here to show what addition or multiplication mean in relation to numbers and arithmetical operations pictured concretely.

Still other devices have focused on helping the student to become more proficient in recalling memorized mathematical facts, for example, those found in multiplication tables up to ten times ten. These devices take the conventional symbolism taught, sometimes rearranged in a random fashion with slight novelty, and reinforce this same convention to the point that recall is quick, accurate, and automatic, that is, with minimal reflection.

All such devices heretofore suffer from one or more of the following disadvantages with respect to advancing mathematical skills which require an ability to think and reason abstractly: (a) Too much emphasis has been placed on only learning what numbers and mathematical operations on them are concretely. (b) Exclusive focus on recalling memorized mathematical facts or procedures without a deeper understanding of the symbols used to express these facts and their rule-governed interrelationships. (c) Lack of emphasis on following rules, especially with respect to manipulating mathematical symbols, which is a skill at the heart of advanced mathematical reasoning. (d) Instead of encouraging students to extend their basic knowledge of conventional symbolism in novel and unexpected ways (thereby showing the extendable and arbitrary nature of mathematical symbolism), these devices simply repeat conventional symbolism at a basic level, albeit by different illustrative means or perfunctory methods. (e) Lack of awareness of the problem of abstraction in mathematics and the learning of it, which leads to greater difficulties later on when students must learn more advanced mathematics at a high school or university level.

In short, these devices, even if they achieve their aims, fail to acknowledge and/or address the need to develop a mastery of mathematical symbolism that is robust and capable of extending the learning of mathematics into abstract investigations of new and useful areas.

### SUMMARY OF THE INVENTION

In accordance with one embodiment, a mathematical learning device comprising a plurality of puzzle grids, each of which displays four digits in a grid pattern of two rows and two columns. These four digits are in a relationship to one another predetermined according to an arbitrary rule defined mathematically and logically.

### DESCRIPTION OF THE DRAWINGS

The accompanying detailed description which may be best understood in conjunction with the accompanying diagrams where like parts in each of the several diagrams are labeled with like numbers, and where:

FIG. 1 shows a computer system for executing a mathematical learning device and method;

FIG. 2A shows a puzzle grid of four digits which incorporates the solution to the different puzzle grid of four digits shown in FIG. 2B;

FIG. 2B shows a puzzle grid of four digits which incorporates the solution to the different puzzle grid of four digits shown in FIG. 2A;

FIG. 3A shows a puzzle of two shared puzzle grids with the shared digit region not displaying a digit indicium but instead being blank;

FIG. 3B shows the same puzzle of two shared puzzle grids shown in FIG. 3A but now displaying a digit indicium in the shared digit region as the puzzle's solution;

FIG. 4A shows a puzzle grid with two variable indicia in place of the two digit indicia in digit regions B and C;

FIG. 4B shows a puzzle grid with two variable indicia in place of the two digit indicia in digit regions A and C;

FIG. 4C shows a puzzle grid with two variable indicia in place of the two digit indicia in digit regions B and D;

FIG. 4D shows two shared puzzle grids with two variable indicia in place of the two digit indicia in digit region A of the upper right puzzle grid and shared digit region E;

FIG. 5 is a pseudocode listing for a first stage that generates a list of valid puzzles for the mathematical learning device;

FIG. 6 is a pseudocode listing for a second stage that generates a list of unknown factors for all valid puzzles for the mathematical learning device;

FIGS. 7A and 7B is a pseudocode listing for a third stage that generates a list of substitute values for all valid puzzles for the mathematical learning device;

FIG. 8 is a pseudocode listing for verifying that the top row of one puzzle always has a corresponding identical bottom row in another puzzle; and

FIG. 9 is a pseudocode listing for verifying that the left column of one puzzle always has a corresponding identical right column in another puzzle.

### DETAILED DESCRIPTION OF THE ILLUSTRATED EMBODIMENTS

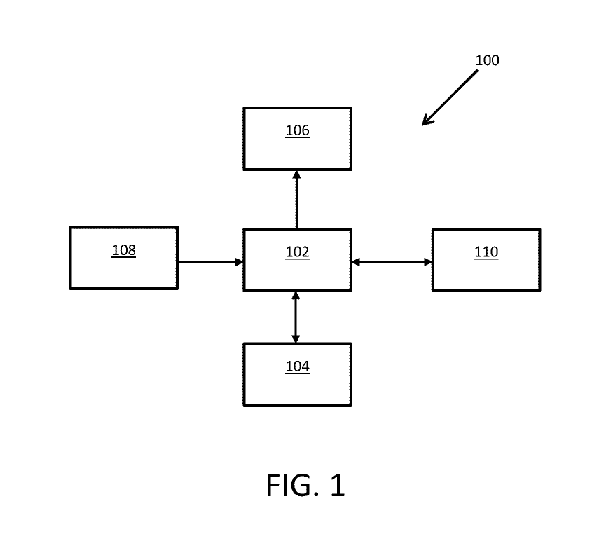

As shown in FIG. 1, there is provided a computing structure 100 comprising at least one processor 102 executing instructions from and storing data to at least one tangible computer-readable medium 104, such as a computer hard drive, RAM, ROM, etc. The at least one processor 102 may receive user input via an input device 108, such as a keyboard, touch screen, etc. The at least one processor 102 may provide human-readable output via an output device 106, such as a computer monitor, liquid crystal display (LCD), printer, etc. The at least one processor 102 may also communicate with other processing structures 100 via a transceiver 110 that communicates over a network, such as the Internet. The computer-readable medium 104 stores instructions to configure the at least one processor 102 to transform into a mathematical learning device in accordance with the method as described herein.

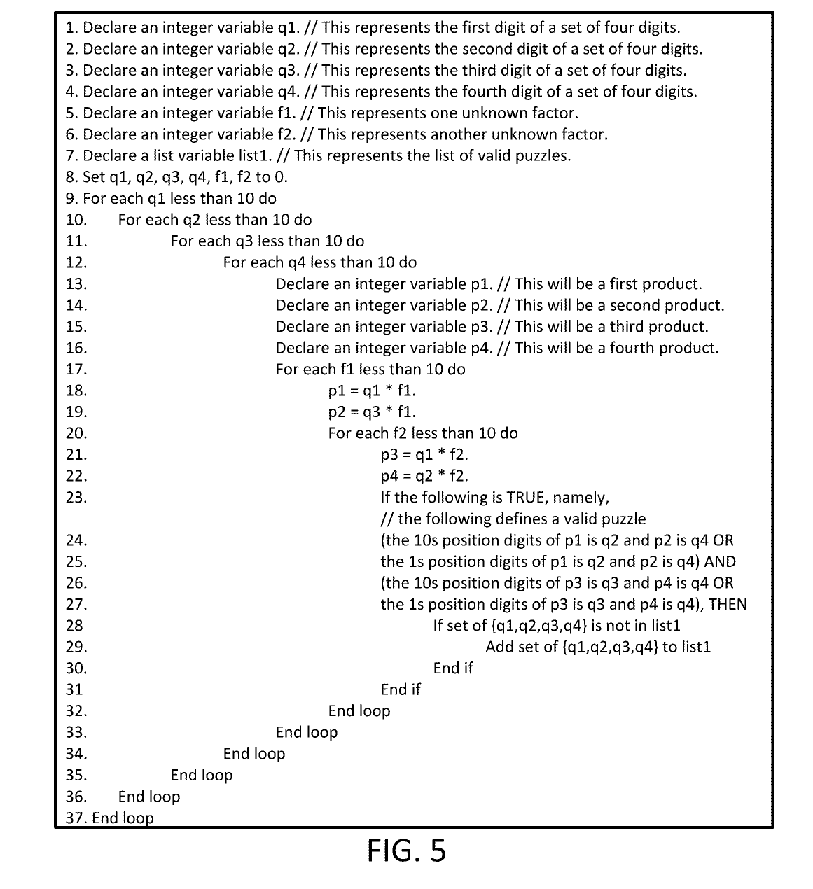

Each mathematical device may comprise a puzzle implemented by a method executed by the processing structure 100. The processing structure 100 may generate and validate every possible puzzle, including all solutions represented by a multiplier indicia 22 and 32. In this aspect, 737 different valid puzzles may be generated according to method described with reference to FIGS. 5 to 9 below.

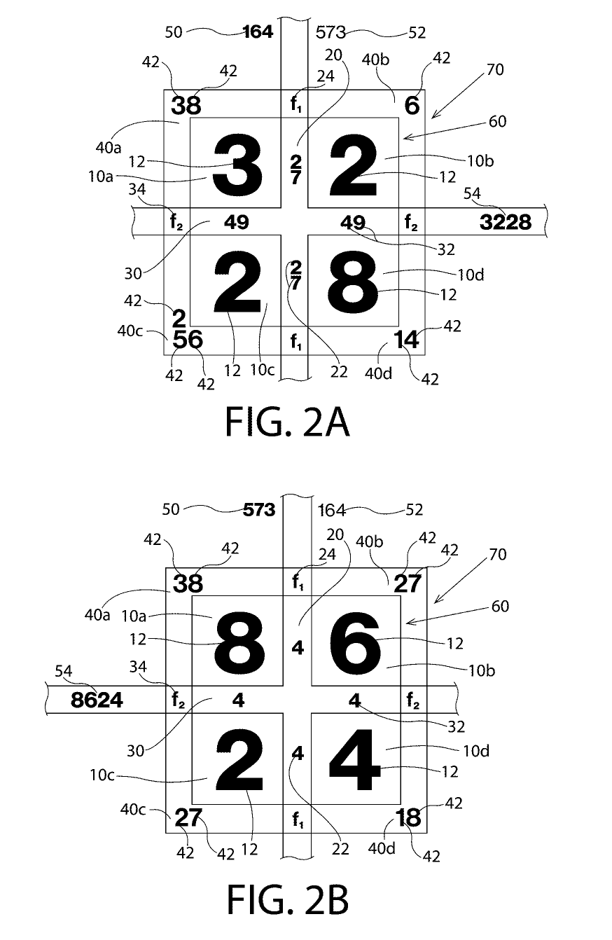

One aspect of the mathematical learning device may be in the form of a number puzzle, illustrated in FIGS. 2A and 2B. FIGS. 2A and 2B each show a single puzzle comprising a single puzzle grid 60. In addition to this single puzzle grid 60, a solution grid 70 may be incorporated into and around each puzzle grid 60. The relationship between the puzzle grids 60 and the solution grids 70 of FIGS. 2A and 2B may be such that the puzzle grid 60 of FIG. 2A has its solution in the solution grid 70 of FIG. 2B, and the puzzle grid 60 of FIG. 2B has its solution in the solution grid 70 of FIG. 2A. In one aspect, the puzzle grid 60 of FIG. 2A is shown on one side of a page, for example, while the puzzle grid 60 of FIG. 2B is shown on the verso side of the same page leaf. In another aspect, the puzzle grid 60 of FIG. 2A may be shown in a different page non-adjacent to the puzzle grid 60 of FIG. 2B. In this way, only one of the puzzles of FIGS. 2A and 2B may be shown at one and the same time, thereby preventing each puzzle and its own solution from appearing together on the same side of the same page or on two pages facing each other.

The puzzle grid 60 in FIG. 2A comprises the four digit regions A, B, C, D 10a, 10b, 10c, 10d arranged in a grid pattern of two rows and two columns: digit region A 10a and digit region B 10b form the top row, digit region C 10c and digit region D 10d form the bottom row, digit region A 10a and digit region C 10c form the left column, and digit region B 10b and digit region D 10d form the right column. In each of the digit regions A, B, C, D 10a, 10b, 10c, 10d there is one digit indicium 12. All four digit indicia 12 make up the puzzle to be solved, namely, the digits ‘3’, ‘2’, ‘2’, and ‘8’. In digit region A 10a is the digit indicium 12 ‘3’. In digit region B 10b is the digit indicium 12 ‘2’. In digit region C 10c is the digit indicium 12 ‘2’. And in digit region D 10d is the digit indicium 12 ‘8’.

The digit regions A and C 10a, 10c are separated from the digit regions B and D 10b, 10d by a multiplier column region 20, while the digit regions A and B 10a, 10b are separated from the digit regions C and D 10c, 10d by a multiplier row region 30. The multiplier regions 20, 30 intersect one another to form a cross pattern. The multiplier column region 20 is identified by a multiplier column label 24 ‘f₁’ and the multiplier row region 30 is identified by a multiplier row label 34 ‘f₂’. Within the multiplier column region 20 are multiplier column indicia 22. These multiplier column indicia 22 are grouped together and repeated twice, each group positioned between the first and second rows of the puzzle grid 60. In FIG. 2A the multiplier column indicia 20 are ‘2’ and ‘7’, and these are grouped twice, between the digit indicia 12 in the first row, namely, between ‘3’ and ‘2’, and in the second row, namely, between ‘2’ and ‘8’. A similar arrangement exists for the multiplier row indicia 32 in the multiplier row region 30. In FIG. 2A, the multiplier row indicia 32 are ‘4’ and ‘9’, and these are again grouped twice, between the digit indicia 12 in the first column, namely, between ‘3’ and ‘2’, and in the second column, namely, between ‘2’ and ‘8’.

Surrounding and adjacent to the digit regions A, B, C, D 10a, 10b, 10c, 10d are in respective order the substitute digit region A 40a, the substitute indicium digit region B 40b, the substitute digit region C 40c, and the substitute digit region D 40d. In each of the corners of the substitute digit regions A, B, C, D 40a, 40b, 40c, 40d are one or more substitute digit indicia 42. In FIG. 2A, the substitute digit indicia 42 in the substitute digit region A 40a are the indicia ‘3’ and ‘8’. The substitute digit indicium 42 in the substitute digit region B 40b is the indicium ‘6’. The substitute digit indicia 42 in the substitute digit region C 40c are the indicia ‘2’, ‘5’, and ‘6’. The substitute digit indicia 42 in the substitute digit region D 40d are the indicia ‘1’ and ‘4’.

The solution grid 70 shown in FIG. 2A comprises the multiplier row indicia 32, the multiplier column indicia 22, and all substitute digit indicia 42. As explained above, this solution grid 70 of FIG. 2A shows the solution to the puzzle grid 60 of FIG. 2B.

All the indicia discussed so far in FIG. 2A relate to the puzzle grid 60 and solution grid 70. The digit indicia 12 relate to one puzzle and all the remaining indicia 22, 32, 42 relate to the solution of the other paired puzzle in FIG. 2B. In order to identify these two puzzles, both puzzles are given unique reference numbers: the puzzle shown has a puzzle reference number 50 and the opposing puzzle, whose solution is shown, an opposing reference number 52. In FIG. 2A, the former refers to the puzzle shown on the current page and has the value ‘164’, while the latter refers to the puzzle on the page opposite and has the value ‘573’. We can further distinguish these two reference numbers 50, 52 from each other by noting that the puzzle reference number 50 is bolded while the opposing puzzle reference number 52 is not. These reference numbers 50, 52 are positioned above the substitute digit regions A and B 40a, 40b.

In order to identify and emphasize the particular puzzle that is being shown, the shown puzzle may also be given a unique puzzle reference name 54. In this case, the name is simply the conjunction of the four digit indicia 12 written together, that is, the reference name 54 given to the puzzle in FIG. 2A is ‘3228’. This reference name 54 is positioned to the right of the substitute digit regions B and D 40b, 40d.

FIG. 2B shows the puzzle grid 60 whose solution is shown in the solution grid 70 of FIG. 2A. This puzzle grid 60 may be substantially identical in structure to the puzzle grid 60 of FIG. 2A detailed above. The puzzle grid 60 in FIG. 2B comprises the four digit regions A, B, C, D 10a, 10b, 10c, 10d arranged in a grid pattern of two rows and two columns: digit region A 10a and digit region B 10b form the top row, digit region C 10c and digit region D 10d form the bottom row, digit region A 10a and digit region C 10c form the left column, and digit region B 10b and digit region D 10d form the right column. In each of the digit regions A, B, C, D 10a, 10b, 10c, 10d there is one digit indicium 12. All four digit indicia 12 make up the puzzle to be solved, namely, the indicia ‘8’, ‘6’, ‘2’, and ‘4’. In digit region A 10a is the digit indicium 12 ‘8’. In digit region B 10b is the digit indicium 12 ‘6’. In digit region C 10c is the digit indicium 12 ‘2’. And in digit region D 10d is the digit indicium 12 ‘4’.

The digit regions A and C 10a, 10c are separated from the digit regions B and D 10b, 10d by a multiplier column region 20, while the digit regions A and B 10a, 10b are separated from the digit regions C and D 10c, 10d by a multiplier row region 30. The multiplier regions 20, 30 intersect one another to form a cross pattern. The multiplier column region 20 is identified by a multiplier column label 24 ‘f₁’ and the multiplier row region 30 is identified by a multiplier row label 34 ‘f₂’. Within the multiplier column region 20 are multiplier column indicia 22. These multiplier column indicia 22 are grouped together and repeated twice, each group positioned between the first and second rows of the puzzle grid 60. In FIG. 2B the multiplier column indicium 20 is ‘4’, and these are grouped twice, between the digit indicia 12 in the first row, namely, between ‘8’ and ‘6’, and in the second row, namely, between ‘2’ and ‘4’. A similar arrangement exists for the multiplier row indicia 32 in the multiplier row region 30. In FIG. 2B the multiplier row indicium 32 is ‘4’, and these are again grouped twice, between the digit indicia 12 in the first column, namely, between ‘8’ and ‘2’, and in the second column, namely, between ‘6’ and ‘4’.

Surrounding and adjacent to the digit regions A, B, C, D 10a, 10b, 10c, 10d are in respective order the substitute digit region A 40a, the substitute digit region B 40b, the substitute digit region C 40c, and the substitute digit region D 40d. In each of the corners of the substitute digit regions A, B, C, D 40a, 40b, 40c, 40d are one or more substitute digit indicia 42. In FIG. 2B the substitute digit indicia 42 in the substitute digit region A 40a are the indicia ‘3’ and ‘8’. The substitute digit indicia 42 in the substitute digit region B 40b are the indicia ‘2’ and ‘7’. The substitute digit indicia 42 in the substitute digit region C 40c are the indicia ‘2’ and ‘7’. The substitute digit indicia 42 in the substitute digit region D 40d are the indicia ‘1’ and ‘8’.

The solution grid 70 shown in FIG. 2B comprises the multiplier row indicia 32, the multiplier column indicia 22, and all substitute digit indicia 42. As explained above, this solution grid 70 of FIG. 2B shows the solution to the puzzle grid 60 of FIG. 2A.

All the indicia discussed so far in FIG. 2B relate to the puzzle grid 60 and solution grid 70. The digit indicia 12 relate to one puzzle and all the remaining indicia 22, 32, 42 relate to the solution of the other paired puzzle in FIG. 2A. In order to identify these two puzzles easily, both puzzles are given unique reference numbers: the puzzle shown has a puzzle reference number 50 and the opposing puzzle, whose solution is shown, an opposing reference number 52. In FIG. 2B the former refers to the puzzle shown on the current page and has the value ‘573’, while the latter refers to the puzzle on the page opposite and has the value ‘164’. We can further distinguish these two reference numbers 50, 52 from each other by noting that the puzzle reference number 50 is bolded, while the opposing puzzle reference number 52 is not. These reference numbers 50, 52 are positioned above the substitute digit regions A and B 40a, 40b.

In order to identify and emphasize the particular puzzle that is being shown, the shown puzzle may also be given a unique puzzle reference name 54. In this case, the name is simply the conjunction of the four digit indicia 12 written together, that is, the reference name 54 given to the puzzle in FIG. 2B is ‘8624’. This reference name 54 is positioned to the left of the substitute digit regions A and C 40a, 40c.

The puzzles and their respective solutions shown in the puzzle grids 60 and solution grids 70 of both FIGS. 2A and 2B may be understood further by explaining the meaning of the digit indicia 12, multiplier column indicia 22, multiplier row indicia 32, and substitute digit indicia 42. Each puzzle grid is governed by a rule which relates all the digit indicia 12 to one another in conjunction with the multiplier column and row indicia 22, 32. This rule can be described in ordinary language as follows:

“The two digits in the first column of the puzzle grid, when multiplied by any multiplier from 0 to 9, produces products such that the corresponding two digits in the second column of the puzzle grid are the digits taken from either the tens position of both products or the ones position of both products. Similarly, the two digits in the first row of the puzzle grid, when multiplied by any multiplier from 0 to 9, produces products such that the corresponding two digits in the second row of the puzzle grid are the digits taken from either the tens position of both products or the ones position of both products.”

This rule may be formulated more precisely in the following way. Let A, B, C, D be variables representing the four digits of a puzzle grid and F and F′ be variables representing any multipliers whose values can each be one of ten values from 0 to 9 inclusive. Furthermore, let W, W′, Y, and Y′ be variables representing tens position digits and X, X′, Z, and Z′ be variables representing ones position digits, whose values can also each be one of ten values from 0 to 9 inclusive. If the following equations are then given relating these variables, so that all products are represented in terms of ten's and one's position values, namely,

FA=10W+X,

FC=10Y+Z,

F′A=10W′+X′,

F′B=10Y′+Z′,

then the following logical relationship (e.g. the rule) defines every valid puzzle grid:

(((B=W)&(D=Y))v((B=X)&(D=Z)))&

(((C=W′)&(D=Y′))v((C=X′)&(D=Z′))).

In the above statement, ‘v’ refers to the logical inclusive OR operator and ‘&’ refers to the logical AND operator.

Given the rule stated above, the variables defined can now be related to each puzzle and its solution in both FIGS. 2A and 2B. In FIG. 2A, A=3, B=2, C=2, D=8. In FIG. 2B, A=8, B=6, C=2, D=4. For all valid puzzles, then, A is shown as the digit indicium 12 in digit region A 10a, B is shown as the digit indicium 12 in digit region B 10b, C is shown as the digit indicium 12 in digit region C 10c, D is shown as the digit indicium 12 in digit region D 10d, F is shown as the multiplier column indicia 22 in the multiplier column region 20, and F′ is shown as the multiplier row indicia 32 in the multiplier row region 30. The following relationships are also established. The substitute indicia 42 in the substitute digit region A 40a are all those digits validly conforming to the rule above given the digit indicium 12 in the digit region B 10b, the digit indicium 12 in the digit region C 10c, and the digit indicium 12 in the digit region D 10d. The substitute indicia 42 in the substitute digit region B 40b are all those digits validly conforming to the rule above given the digit indicium 12 in the digit region A 10a, the digit indicium 12 in the digit region C 10c, and the digit indicium 12 in the digit region D 10d. The substitute indicia 42 in the substitute digit region C 40c are all those digits validly conforming to the rule above given the digit indicium 12 in the digit region A 10a, the digit indicium 12 in the digit region B 10b, and the digit indicium 12 in the digit region D 10d. The substitute indicia 42 in the substitute digit region D 40d are all those digits validly conforming to the rule above given the digit indicium 12 in the digit region A 10a, the digit indicium 12 in the digit region B 10b, and the digit indicium 12 in the digit region C 10c.

Let's now examine in detail how the rule governing every puzzle is applied to the specific puzzles depicted in FIG. 2A and FIG. 2B. In FIG. 2A, the digit indicia 12 are ‘3’, ‘2’, ‘2’, and ‘8’. The column and row indicia 22, 32 to this puzzle (referred to by the reference number 50 as ‘164’) are found in FIG. 2B and these are both ‘4’. According to the puzzle rule, then,

3×4=12 or (1×10)+2,

2×4=8 or (0×10)+8,

3×4=12 or (1×10)+2,

2×4=8 or (0×10)+8.

When the digit indicia 12 of the first column (FIG. 2A) is multiplied by the column indicia 22 of the solution (FIG. 2B), both products' ones position values correspond to the digit indicia 12 of the second column (FIG. 2A), that is, to ‘2’ and ‘8’. Similarly, when the digit indicia 12 of the first row (FIG. 2A) is multiplied by the row indicia 22 of the solution (FIG. 2B), both products' ones position values correspond to the digit indicia 12 of the second row (FIG. 2A), that is, again to ‘2’ and ‘8’.

The puzzle given in FIG. 2B can also be analyzed in the same way. In FIG. 2B, the digit indicia 12 are ‘8’, ‘6’, ‘2’, and ‘4’. The column indicia 22 to this puzzle (referred to by the reference number 50 as ‘573’) are found in FIG. 2A and these are ‘2’ and ‘7’. Although the ‘2’ and ‘7’ are presented vertically as ‘27’ in FIG. 2A, in other aspects, the ‘2’ and ‘7’ may be presented as ‘72’. In the aspects presented herein, these values are listed in ascending order. The row indicia 32 to this puzzle are also found in FIG. 2A and these are ‘4’ and ‘9’. According to the puzzle rule, then, the equations involving the column indicia 22 of FIG. 2A are:

8×2=16 or (1×10)+6,

2×2=4 or (0×10)+4,

8×7=56 or (5×10)+6,

2×7=14 or (1×10)+4.

The equations involving the row indicia 22 of FIG. 2A are:

8×4=32 or (3×10)+2,

6×4=24 or (2×10)+4,

8×9=72 or (7×10)+2,

6×9=54 or (5×10)+4.

What we find is that when we multiply the digit indicia 12 of the first column (FIG. 2B) by the column indicia 22 of the solution (FIG. 2A), both products' ones position values correspond to the digit indicia 12 of the second column (FIG. 2B), that is, to ‘6’ and ‘4’. Similarly, we find that when we multiply the digit indicia 12 of the first row (FIG. 2B) by the row indicia 22 of the solution (FIG. 2A), both products' ones position values correspond to the digit indicia 12 of the second row (FIG. 2B), that is, to ‘2’ and ‘4’.

In another aspect, the substitute digit indicia 42 in the substitute digit regions A, B, C, D 40a, 40b, 40c, 40d of both FIG. 2A and FIG. 2B may be solved to produce another valid solution. For each digit indicium 12 there is a corresponding set of substitute digit indicia 42 with at least one substitute digit indicium 42 that is identical to said digit indicium 12. The substitute digit indicia 42 are all those indicia that can each be substituted for said digit indicium 12 and the rule governing all four digit indicia 12 is still satisfied. For example, in FIG. 2A the four digit indicia 12 are ‘3’, ‘2’, ‘2’, and ‘8’. In this example, the digit indicium 12 ‘8’ in the digit region D 10d is illustrated. The corresponding substitute digit indicia 42 for this digit indicium 12 are shown in the corresponding substitute digit region D 40d of FIG. 2B (e.g. the solution grid for FIG. 2A), namely, the substitute digit indicia 42 ‘1’ and ‘8’. It is already known that ‘8’ satisfies the rule governing the four digit indicia 12 of FIG. 2A and therefore ‘8’ is shown as one of the substitute digit indicia 42. The alternative solution is ‘1’ as this number can be substituted for ‘8’ in the rule governing the four digit indicia 12, because of the following analysis:

3×7=21 or (2×10)+1,

2×7=14 or (1×10)+4,

3×7=21 or (2×10)+1,

2×7=14 or (1×10)+4.

The substitute digit indicium 42 ‘1’ is allowed because ‘1’ here is the tens position number of the corresponding product, just as the digit indicium 12 ‘2’ is now also a tens position number of its corresponding product. In this example, the solution for F and F′ has been changed to ‘7’ allowing in order for the rule to be satisfied. For each of the four digit indicium 12 of a puzzle grid, therefore, there corresponds a set of substitute digit indicia 42 in its corresponding solution grid, as is shown in FIGS. 2A and 2B. As another example to clarify this connection, given the digit indicia 12 of FIG. 2B, the substitute digit indicia 42 in FIG. 2A corresponding to the digit indicium 12 ‘2’ in digit region C 10c of FIG. 2B are ‘2’, ‘5’ and ‘6’ as shown in Tables 1, 2, and 3 below. For Table 1, f₁ and f₁′ may be 2 (e.g. 8×2=16 and 2×2=4) or 7 (e.g. 8×7=56 and 2×7=14) and f₂ and f₂′ may be 4 (e.g. 8×4=32 and 6×4=24) and/or 9 (e.g. 8×9=72 and 6×9=54). For Table 2, f₁ may be 8 (e.g. 8×8=64 and 6×8=48) and f₂ may also be 7 (e.g. 8×7=56 and 6×7=42). For Table 3, f₁ may be 8 (e.g. 8×8=64 and 6×8=48) and f₂ may be 8 (e.g. 8×8=64 and 6×8=48).

TABLE 1

| | | |
|---|---|---|
| 8 | 2 7 | 6 |
| 4 9 | | 4 9 |
| 2 | 2 7 | 4 |

TABLE 2

| | | |
|---|---|---|
| 8 | 8 | 6 |
| 7 | | 7 |
| 5 | 8 | 4 |

TABLE 3

| | | |
|---|---|---|
| 8 | 8 | 6 |
| 8 | | 8 |
| 6 | 8 | 4 |

The function of the substitute digit indicia 42 is to further test the learner's understanding of the puzzle rule, such that, given any three of the four digit indicia, the solver may work out all other indicia that are possible as a substitute for the fourth and last remaining digit indicia 12, so long as each such digit indicium 12 still forms a valid set of digit indicia 12 according to the definition of the puzzle rule.

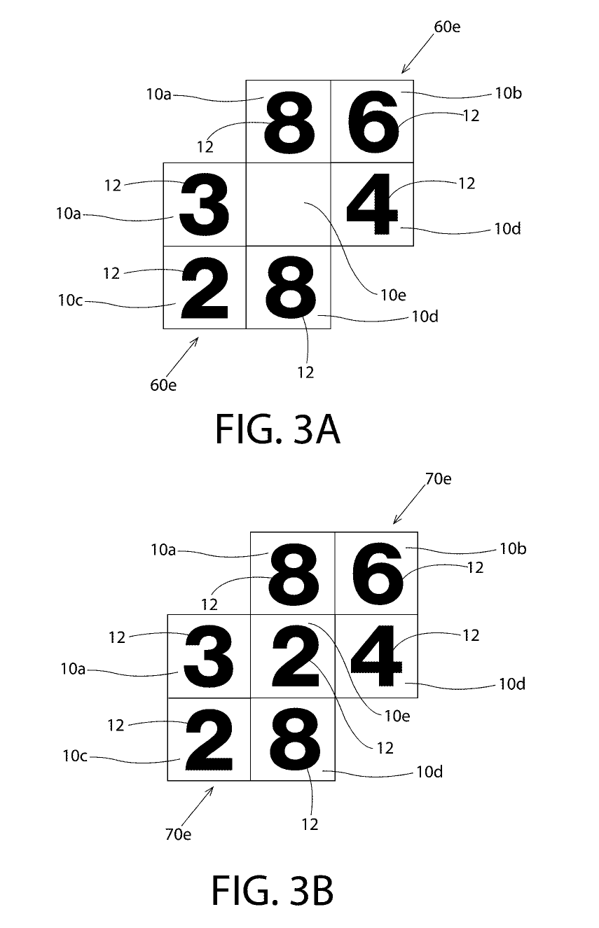

In another aspect, the puzzle of FIG. 3A comprises more than one shared puzzle grid 60e. These shared puzzle grids 60e are connected to one another such that at least one of the digit indicia 12 coincides or is shared with at least one digit indicium 12 of another shared puzzle grid 60e. This “sharing” occurs in the shared digit region E 10e, which now substitutes for any of the digit regions A, B, C, or D 10a, 10b, 10c, 10d defined above with reference to FIGS. 2A and 2B. Thus, in one shared puzzle grid 60e, the shared digit region E 10e can substitute for the digit region B 10b, while in another connected shared puzzle grid 60e, this same shared digit region E 10e can substitute for the digit region C 10c. In the description of the aspect described with reference to FIGS. 2A and 2B, the digit region B 10b is immediately to the right of the digit region A 10a and immediately upward of the digit region D 10d. In the lower left shared puzzle grid 60e of FIG. 3A, the digit region E 10e is immediately to the right of the digit region A 10a and immediately upward of the digit region D 10d.

As can be seen in FIG. 3A, the shared digit region E 10e substitutes for the digit region B 10b in the lower left shared puzzle grid 60e. Similarly, in the description of the puzzle of FIGS. 2A and 2B, the digit region C 10c is immediately downward of the digit region A 10a and immediately to the left of the digit region D 10d. In the upper right shared puzzle grid 60e of FIG. 3A, the digit region E 10e is immediately downward of the digit region A 10a and immediately to the left of the digit region D 10d. The shared digit region E 10e substitutes for the digit region C 10c in the upper right shared puzzle grid 60e. The solution of the puzzle of FIG. 3A is shown in FIG. 3B. Here the shared solutions grids 70e correspond to the shared puzzle grids 60e of FIG. 3A with the difference that the digit region E 10e now contains the solution digit indicia 12 ‘2’.

FIG. 3A presents an additional puzzle by which to challenge those learning basic skills in mathematics where the shared digit region 10e contains no digit indicium 12 and it is left to the puzzle solver to determine what digit indicium 12 would make both shared puzzle grids 60e valid groups of four digit indicia 12 according to the rule. The solution is shown in the shared solution grids 70e of FIG. 3B.

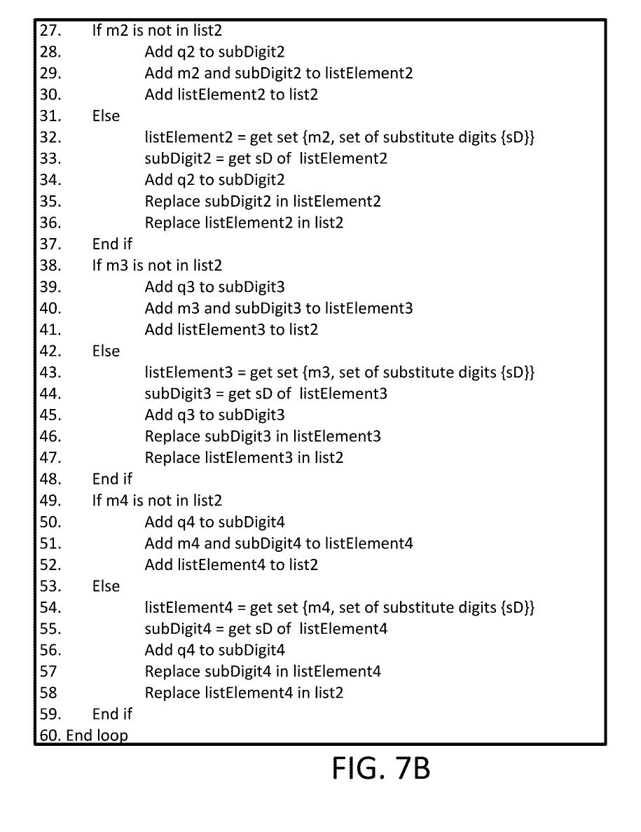

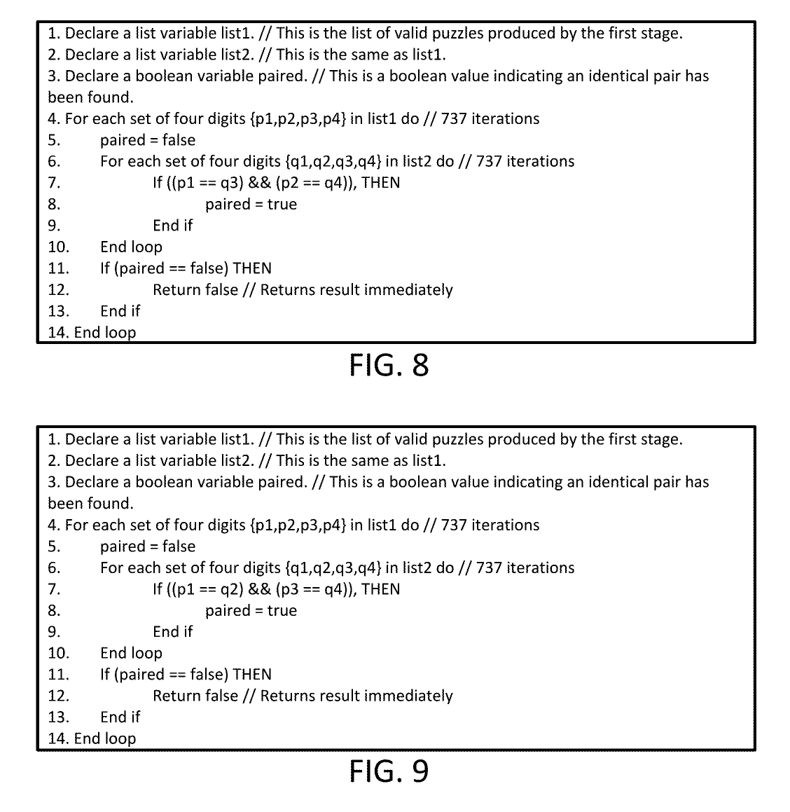

The variety of new puzzles may be created in this alternative aspect extending beyond the aspect described with reference to FIGS. 2A and 2B where there are exactly 737 groups of four digit indicia that satisfy the rule. It can be further shown, by the processes presented with reference to FIGS. 8 and 9 below, that every combination of two digit indicia in the top row of a shared puzzle grid also has an identical corresponding pair of digit indicia in the lower row of some other shared puzzle grid. Also, every combination of two digit indicia in the left column of a shared puzzle grid also has an identical corresponding pair of digit indicia in the right column of some other shared puzzle grid. This means that, given any one of the 737 possible valid puzzle grids under the rule, there may be at least one other puzzle grid whose top row, bottom row, left column, or right column of two digit indicia may overlap with either the top row, bottom row, left column, or right column of two digit indicia of that given puzzle grid. Hence, a puzzle of any size may be created in this alternative aspect. For the sake of simplicity and generality in the description, the puzzle of FIG. 3A shows a minimally-sized puzzle, that is, shared puzzle grids 60e with only one shared digit region E 10e.

The puzzle solver may be provided with the puzzle of FIG. 3A and asked to determine, according to the rule governing all shared puzzle grids 60e, the missing digit indicium 12 of the shared digit region E 10e. The solution grids 70e of FIG. 3B, then, show the solution by revealing the digit indicium 12 of the shared digit region E 10e, namely, ‘2’. The solution of ‘2’ is determined by f₁ and f₁′ being either 2 (e.g. top row is 8×2=16) or 7 (e.g. top row is 8×7=56). Therefore, digit region E 10e would have to be ‘2’ to satisfy the middle row (e.g. 2×2=4 or 2×7=14). Similarly, f₂ must be 4 (e.g. bottom row is 2×4=8) and therefore middle is also satisfied (e.g. 3×2=12). Further details in puzzle solver's reasoning is given below.

Let's now see how a puzzle solver might go about solving the puzzle of FIG. 3A, in order to illustrate the operation of this alternative aspect. When we look at the group of four digit indicia 12 in the lower left shared puzzle grid 60e in FIG. 3B, the three digit indicia 12 shown are identical to those digit indicia 12 in FIG. 2A that are in the same relative positions, namely, ‘3’ in digit region A 10a, ‘2’ in digit region C 10c, and ‘8’ in digit region D 10d. In the description of the first aspect above, there are substitute digit indicia 42 shown in FIG. 2B which are connected to these three digit indicia 12 as shown in FIG. 2A, namely, ‘2’ and ‘7’. The puzzle solver may similarly try to determine the digit indicium 12 in the shared digit region E 10e of FIG. 3A. The solver is trying to find all possible digit indicia 12 which are valid substitutes according to the rule. Having arrived then at the same answer, namely, ‘2’ and ‘7’, there would so far be two possible digit indicia 12 that would provide a corresponding answer for the lower left shared puzzle grid 60e of FIG. 3A.

But there is yet another shared puzzle grid 60e in the upper right of FIG. 3A in which three digit indicia 12 are shown, namely, ‘8’ in the digit region A 10a, ‘6’ in the digit region B 10b, and ‘4’ in the digit region D 10d. These, again, correspond with three digit indicia 12 of FIG. 2B, whose substitute digit indicia 42 corresponding to them are shown in FIG. 2A, namely, ‘2’, ‘5’ and ‘6’. Therefore, the digit indicium 12 in the shared digit region E 10e of FIG. 3A could also be a ‘2’, ‘5’, or ‘6’ in order to be a valid shared puzzle grid 60e. It is clear, however, that the digit indicium 12 in the shared digit region E 10e of FIG. 3A must be a digit indicium 12 that is the union of both sets of substitute digit indicia 42 mentioned as relevant to our shared puzzle grids 60e. There is only one such substitute digit indicium 42 that satisfies this requirement, namely, the substitute digit indicium 42 ‘2’. The puzzle solver will therefore conclude, by reasoning similarly about the shared puzzle grids 60e of FIG. 3A, that the digit indicium 12 in the shared digit region E 10e of FIG. 3A must be ‘2’, which is now shown in the solution grids 70e as the digit indicium 12 ‘2’ in the shared digit region E 10e of FIG. 3B.

Turning to FIGS. 5 to 7B, there is provided a method, shown as pseudocode, for an efficient generation and validation of puzzles for the learning device. A first stage is presented in FIG. 5 where a list of all valid puzzles may be generated. The first stage involves six nested iterative loops to produce all 1,000,000 combinations of four decimal digits and two unknown factors (e.g. 10×10×10×10×10×10) and to test each against the mathematical and logical statement defining the valid puzzle combination. Each valid puzzle combination may then be added to a list of valid puzzles. The first stage begins by declaring variables in steps 1 to 7 and initializing the variables q1 to q4 and f1 and f2 to zero at step 8. In steps 9 to 12, q1 to q4 are iterated from zero to ten. For each combination of q1 to q4, a product p1 to p4 may be declared in steps 13 to 16. For each f1 value less than 10 (at step 17), products p1 and p2 may be generated by p1=q1*f1 and p2=q3*f1 (at steps 18 and 19). Also for each f1 value less than 10 (at step 17), another loop for f2 less than 10 (step 20) may produce products p3 and p4 by p3=q1*f2 and p4=q2*f2 in steps 21 and 22 accordingly. At step 23 to 27, a valid puzzle may be determined by (the 10s position digits of p1 is q2 and p2 is q4 OR the is position digits of p1 is q2 and p2 is q4) AND (the 10s position digits of p3 is q3 and p4 is q4 OR the is position digits of p3 is q3 and p4 is q4). If the puzzle is valid, the first stage determines if the values of q1 to q4 are not in the list of valid puzzles at step 28 and if not, then the values q1 to q4 are added to the list of valid puzzles at step 29. The remaining steps 30 to 37 close the If statements and/or loops. This first stage will generate a list of 737 valid puzzles comprising sets of four digits q1 to q4.

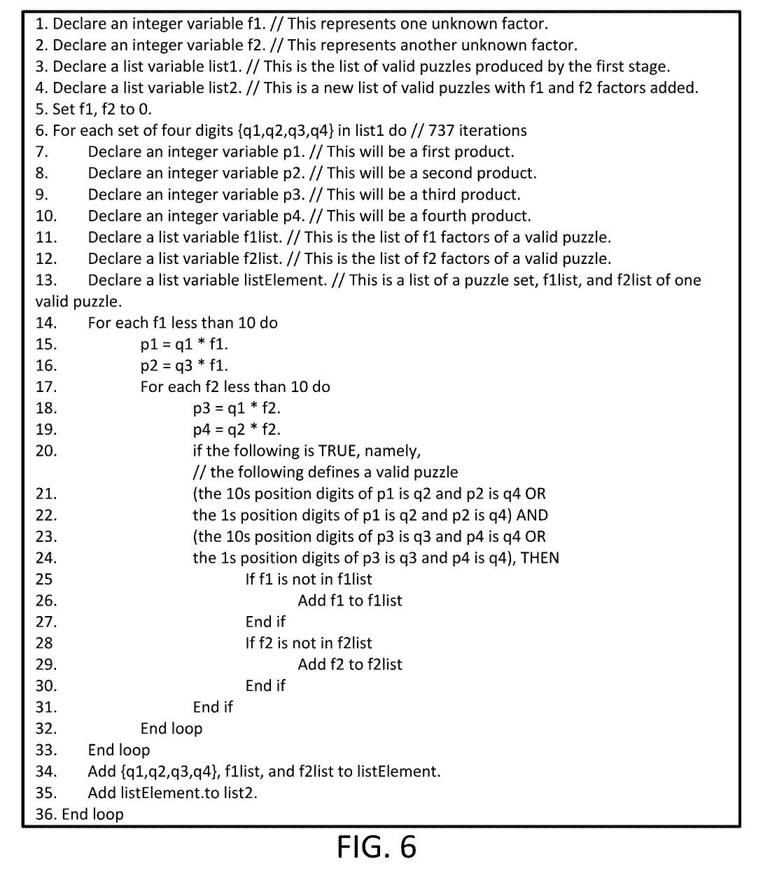

A second stage is presented in FIG. 6 to generate a list of unknown factors f1 and f2 for all valid puzzles. This stage uses a similar method as the first stage but with two nested iterative loops. The same mathematical and logical statement defines a valid puzzle combination but additionally compiles a list of all the f1 and f2 digits. The new list generated by this method has 737 elements, each element having 3 discrete sets: a first set contains a set of four digits (e.g. a valid puzzle), a second set of all unknown f1 factors of this valid puzzle, a third set of all unknown f2 factors of this valid puzzle.

The second stage begins at steps 1 to 4 by declaring unknown factor variables f1, f2 and list variables list1 and list2. The variable list1 comprises the list of valid puzzles produced in the first stage. The variable list2 comprises a new list of valid puzzles with f1 and f2 factors added. At step 5, the unknown factor variables f1 and f2 are initialized to zero. The second stage then iterates through each of the list of valid puzzles (e.g. q1 to q4) at step 6. The list of valid puzzles may have been generated by the first stage. For each iteration, a set of product variables p1 to p4 is declared as well as a pair of lists for the f1 factors f1list and the f2 factors f2list at steps 7 to 12. A list of elements listElement is declared at step 13, which includes a list of a puzzle set, f1list, and f2list of one valid puzzle. For each f1 less than 10 (at step 14), the products p1 and p2 are generated where p1=q1*f1 and p2=q3*f1 at steps 15 and 16 respectively. Also for each f1, f2 is also iterated at step 17 and products p3 and p4 are generated where p3=q1*f2 and p4=q2*f2 at steps 18 and 19 respectively. If the values satisfy (the 10s position digits of p1 is q2 and p2 is q4 OR the is position digits of p1 is q2 and p2 is q4) AND (the 10s position digits of p3 is q3 and p4 is q4 OR the is position digits of p3 is q3 and p4 is q4) at steps 20 to 24, then it is determined if f1 is in f1list at step 25. If f1 is not in f1list, then f1 is added to f1list at step 26. Similarly, if f2 is not in f2list at step 28, then f2 is added to f2list at step 29. Steps 30 to 33 terminate the if statements and the two f1 and f2 loops. The combinations of q1 to q4, f1list, f2list is then added to the list of elements listElement at step 34 and added to list2 at step 35.

Many similar types of puzzle may be created that are more complicated in structure or require similar or different types of strategies. In some puzzles, for example, digit indicia may be shown in some digit regions, while others are not shown and remain to be solved. Also, in this alternative embodiment, some shared digit regions, for example, might have more than one possible digit indicium that solves each connected puzzle grid, in which case all solutions would be shown in the relevant digit region. In addition, some puzzle grids may have more than one shared digit regions in their shared puzzle grids.

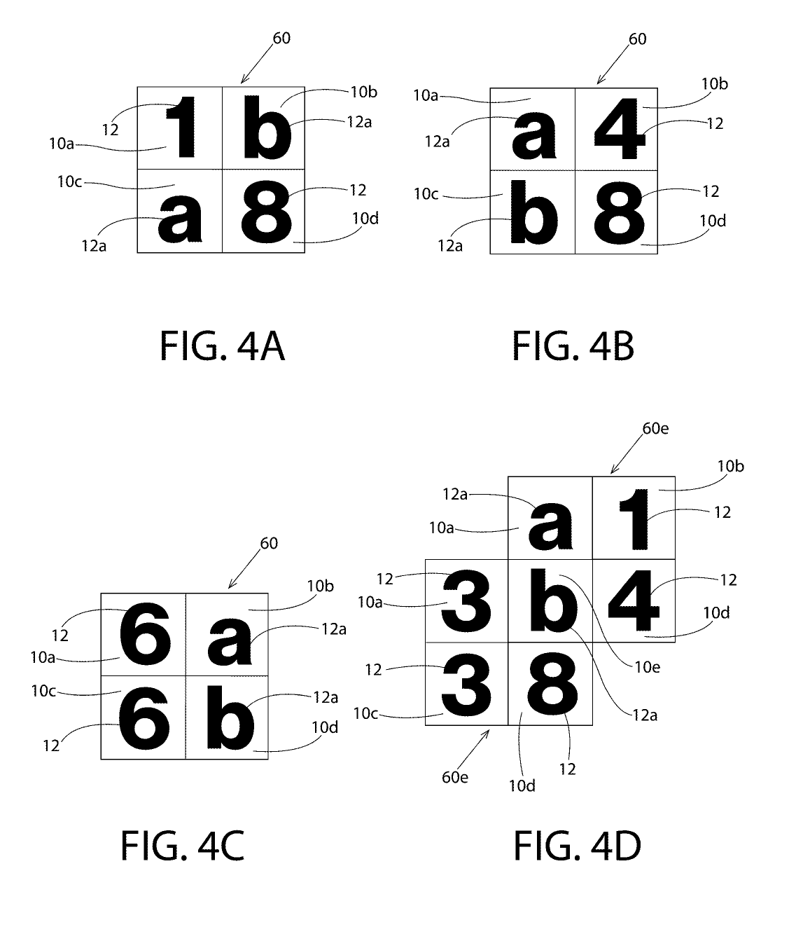

Returning to FIGS. 4A to 4D, yet another alternative aspect may be described. This additional alternative embodiment also uses the same digit indicia 12 and puzzle grids 60, 60e of the first and alternative aspects described with reference to FIGS. 2A and 2B and 3A and 3B above. The same predetermined rule governs these digit indicia 12, but now includes a variable digit indicia 12a. Like the variables of mathematics, the variable digit indicia 12a use symbols to represent, not a single value, but a set of possible values. Thus, the variable digit indicia 12a may represent a set of possible digit indicia 12 as described in the first embodiment. In FIG. 4A, the variable digit indicia 12a ‘a’ and ‘b’ each represent possible digit indicia 12 that would validly be governed in a puzzle grid by the rule. These variable digit indicia 12a in FIG. 4A are placed in the bottom left and top right of the puzzle grid 60. In FIG. 4B, these variable digit indicia 12a are placed in the left column of the puzzle grid 60. In FIG. 4C, these variable digit indicia 12a are placed in the right column of the puzzle grid 60. In FIG. 4D, these variable digit indicia 12a are placed in the left column of the upper right shared puzzle grid 60e and in the shared digit region E 10e of the lower left shared puzzle grid 60e. The solutions to these puzzles may be in the form of a written answer, either prose or mathematical statements, for example, “a is equal to b,” “a<b”, “b is an odd number”, “a, b>0”, and so on.

The operation of the structure of the additional alternative aspect given above is as follows. The puzzles posed in FIGS. 4A to 4D challenge the puzzle solver to determine or state the kind of mathematical knowledge that may be obtained from the positions of the variable digit indicia 12a in each respective puzzle grid 60, 60e. For example, in FIG. 4A, the puzzle may pose a question concerning what may be known about the variable digit indicia 12a ‘a’ and the variable digit indicia 12a ‘b’ in terms of the mathematical relationships of equality, greater than, or less than. That is, must the value represented by ‘a’ and ‘b’ be greater than, less than, or equal to some value that can be determined within the puzzle grid 60? A different question may also be asked about the variable digit indicia 12a ‘a’ and ‘b’, namely, do ‘a’ and ‘b’ represent tens position values, ones position values, or perhaps both. It can be shown mathematically that both ‘a’ and ‘b’ in FIG. 4A must be greater than ‘0’ and that they must be both ones position values. This may be shown using only basic mathematical knowledge and the predetermined rule. The digit indicium 12 in the top left position is ‘1’, which, when multiplied by any multiplier less than ten, is less than ten. Since every multiplier possible according to the predetermined rule is less than ten, the product will always be less than ten. Now if ‘a’ and ‘b’ represented tens position values, they would have to be ‘0’. If they were both ‘0’, furthermore, the digit indicium 12 in the lower right position would also have to be ‘0’, since any multiplier multiplied by ‘0’ produces ‘0’, both in the tens and ones position of the product. But the digit indicium 12 in the lower right is ‘8’. Therefore, both ‘a’ and ‘b’ must be greater than ‘0’ and represent ones position values.

In FIG. 4B the puzzle poses another type of question to be solved by reasoning about the puzzle grid 60 shown. How can we characterize the mathematical relationship between the variable digit indicia 12a ‘a’ and ‘b’? Is ‘a’ greater than, less than, or equal to ‘b’? Or perhaps ‘a’ is not greater than, less than, or equal to ‘b’? What is the answer? It may be reasoned mathematically that ‘a’ cannot be equal to ‘b’. Suppose ‘a’ and ‘b’ are equal. If two numbers are multiplied which are the same by the same multiplier, the products will both be the same. Therefore, both ten's position values and one's position values will also be the same for both products. However, in this case the digit indicia 12 in the right column of the puzzle grid 60 are both different, representing different products. Therefore, ‘a’ and ‘b’ cannot be equal.

The puzzle grid 60 in FIG. 4C poses the same question as the puzzle grid 60 in FIG. 4B but the answer is different. The reasoning, however, is similar. The digit indicia 12 in the left column of the puzzle grid 60 in FIG. 4C are both ‘6’, that is, they are both the same. If two numbers are multiplied which are the same by the same multiplier, the products will both be the same. Therefore, the products in this case will both be the same, and hence both ten's position values and one's position values are the same for both products. Consequently, the variable digit indicia 12a ‘a’ and ‘b’ must both represent the same values and be equal to each other.

FIG. 4D shows two shared puzzle grids 60e with the shared digit region E 10e containing the variable digit indicium 12a ‘b’. This puzzle is similar in shape to the puzzle in FIGS. 3A and 3B. In FIG. 4D, the puzzle requires the puzzle solver to determine what may be known mathematically about the variable digit indicium 12a ‘a’. The solution may be determined by using the same logic as in our descriptions in FIGS. 4B and 4C, since the puzzle grids 60 in FIGS. 4B and 4C, when combined, are similar in structure to the shared puzzle grids 60e in FIG. 4D. For example, the variable digit indicium 12a ‘b’ must be equal to ‘8’ insofar as it is a part of the set of four digit indicia 12 ‘3’, ‘b’, ‘3’, ‘8’ of the lower left shared puzzle grid 60e. The reasoning is identical to that in the description of FIG. 4C. If this is so, then ‘a’ cannot be ‘8’, insofar as it is a part of the set of four digit indicia 12 ‘a’, ‘1’, ‘b’, ‘4’ of the upper right shared puzzle grid 60e while substituting ‘8’ for ‘b’. The reasoning is similar to that in the description of FIG. 4B. Therefore, the solution to the question posed by the puzzle in FIG. 4D is that ‘a’ is not equal to ‘8’.

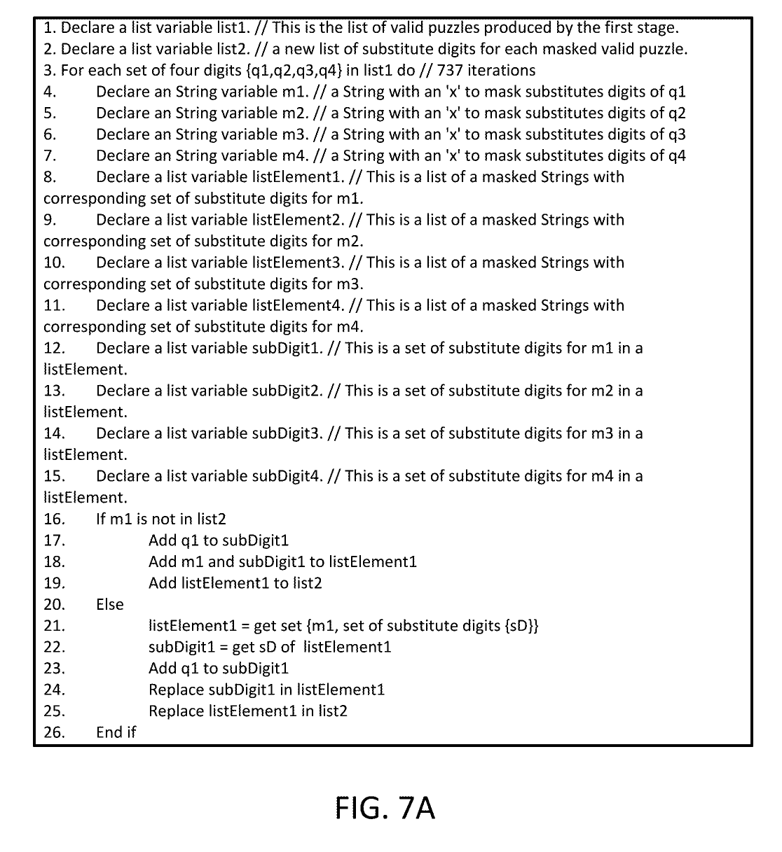

A third stage is presented in FIGS. 7A and 7B to generate a list of substitute digits for all valid puzzles as described above for FIGS. 4A to 4D. This third stage uses a similar method as the first stage but with one iterative loop. The third stage compiles a list of all valid substitute digits of each digit in a valid puzzle (ABCD). The third stage uses the list of valid puzzles from the first stage resulting in a more efficient and shorter execution. A new list generated by this third stage has 1,914 elements, each element having two sets: a first set contains a set of four digits (e.g. a valid puzzle) with a mask ‘x’ for one substitute value and a second set that contains all valid substitute values of the masked set of four digits.

The third stage begins at step 1 with the importation/declaration of the list of valid puzzles list1 produced by the first stage. A new list of substitute values list2 for each masked valid puzzle is also declared at step 2. For each valid puzzle on the list of valid puzzles (step 3), a set of string variables m1 to m4 is declared (steps 4 to 7). For example, for the valid puzzle of four digits ‘8624’, m1 may be ‘x624’, m2 ‘8x24’, m3 ‘86x4’, and m4 ‘862x’. Four list variables listElement1 to listElement4 for each substitute value position (e.g. m1 to m4) are declared at steps 8 to 11. Four more list variables subDigit1 to subDigit4 corresponding to a set of substitute values for m1 to m4 respectively are declared at steps 12 to 15. At step 16, if the substitute value m1 is not within the new list of substitute values list2 (step 16), then q1 is added to the set of substitute values subDigit1 (step 17) and the substitute value m1 and the set of substitute values subDigit1 are added to the list variable listElement1 (step 18). The list variable listElment1 is then added to the new list of substitute values list2 (step 19). If the substitute value m1 is within the new list of substitute values list2 (step 20), then the substitute value m1 and the set of substitute values subDigit1 are retrieved and placed in the list variable listElement1 (step 21). Similarly, the variable subDigit1 is equal to the set of substitute values subDigit1 of the list variable listElement1 (step 22). The variable q1 is added to the set of substitute values subDigit1 (step 23). The set of substitute values subDigit1 is replaced in the list variable listElement1 (step 24) and the list variable listElement1 is replaced in the new list of substitute values list2 (step 25). The if-statement ends at step 26. A similar set of steps is performed for substitute value m2 from steps 27 to 37, substitute value m3 from steps 38 to 48, and substitute value m4 from steps 49 to 59. The process ends at step 60.

Turning now to FIG. 8, a process for validating that a top row of one puzzle has a corresponding identical bottom row in itself or another puzzle is provided. The process may iterate through all 737 valid puzzles and for each one iteration, it iterates through all of the 737 valid puzzles to verify if any top row digits found in the first iterative loop have a corresponding identical bottom row in another puzzle found in the second iterative loop. The process begins by importing or declaring the list variable list1 generated in the first stage (step 1). A duplicate list variable list2 may also be imported or declared (step 2). A Boolean variable paired may be declared (step 3) where the Boolean value paired indicates an identical pair has been found. For each set of four puzzle digits p1 to p4 in the list variable list1 (step 4), the variable paired is set to false at step 5. For each set of the four puzzle digits q1 to q4 in the list variable list2 (step 6), if p1 equals q3 and p2 equals q4 (step 7), then the variable paired is set to true indicating a match has been found. If no match is found (step 11), then the process returns the variable paired is equal to false (step 12).

Similarly to FIG. 8, FIG. 9 presents a process for validating that a left column of one puzzle has a corresponding identical right column in itself or another puzzle. The process may iterate through all 737 valid puzzles and for each one iteration, it iterates through all of the 737 valid puzzles to verify if any left column digits found in the first iterative loop have a corresponding identical right column in another puzzle found in the second iterative loop. The process begins by importing or declaring the list variable list1 generated in the first stage (step 1). A duplicate list variable list2 may also be imported or declared (step 2). A Boolean variable paired may be declared (step 3) where the Boolean value paired indicates an identical pair has been found. For each set of four puzzle digits p1 to p4 in the list variable list1 (step 4), the variable paired is set to false at step 5. For each set of the four puzzle digits q1 to q4 in the list variable list2 (step 6), if p1 equals q2 and p3 equals q4 (step 7), then the variable paired is set to true, indicating a match has been found. If no match is found (step 11), then the process returns the variable paired is equal to false (step 12). In this aspect, the process of FIGS. 8 and 9 should normally never return false in step 12.

The mathematical learning device and method as described may present a number of advantages to improve learning of mathematical concepts. For example, learners may focus on the relative positioning of the digits in a set of four digits governed by a predetermined rule, as the same digit may have several different meanings based on either its position in the puzzle grid or by the rule. This may lead the learner to think more abstractly about digits and their interrelationships, without respect to concrete representations. In another example, learners already exposed to the multiplication table up to nine times nine and to place value notation may have an additional tool with which to deepen their knowledge of these basic mathematical facts by showing that these basic facts are not isolated facts but interconnected. In yet another example, learners may be introduced to a rule-governed set of numbers. This rule-governed understanding may demonstrate the arbitrariness and autonomy of mathematical symbolism and its ability to forge new meanings and interrelationships beyond established conventional meanings. Learners may also understand that even basic mathematical facts and symbols, when combined in a unique way in the form of a rule, may produce a more complicated structure with its own unique mathematical properties, thereby showing how mathematics may branch out and extend beyond what is known and familiar. Educators using the mathematical learning device and method may compress basic mathematical facts, properties, and relationships into sets of four digits governed by a rule, and so minimizing set up time for instruction once the rule is grasped by the student, thereby maximizing instruction time. Simple to complex puzzles may be created to give the learner a greater range of puzzle difficulty, thereby helping to ease the transition from simple to deeper understanding of the predetermined rule.

An axiomatic system may be developed from one aspect of the mathematical learning device describe herein, which would not only show a higher level of abstraction attainable from its arbitrary rule but may also greatly help advance the student who wants to learn more advanced mathematics which are based on axiomatic systems. This device's rule constrains the selection of the four digits of the learning device and thereby makes it possible to reason, through this rule, what can or cannot be a valid selection of four digits. Proving, in a systematic way, what may or may not be a valid selection of four digits based on this rule may be substantially equivalent to providing such an axiomatic system.

Although the stages or processes described herein generate a complete set of puzzles, other aspects may only generate a portion of the set of puzzles. In yet another aspect, only a single puzzle from the set of puzzles may be generated. In some aspects, the one or more puzzles may be generated in response to input on the input device 108 by the user. In some aspects, the puzzle variables and/or unknown factor variables may be generated randomly.

The mathematical learning device of the various aspects herein may be used to further a learner's mathematical skills beyond a concrete grasp of mathematical symbolism.

While the above description contains many specificities, these should not be construed as limitations on the scope of any aspect, but as exemplifications of the presently aspects thereof. Many other ramifications and variations are possible within the teachings of the various aspects. For example, the puzzles and their solutions may be displayed in various media, including but not limited to books, electronic books, computer programs, websites, flash cards, classroom projectors, chalk boards, white boards, monitor screens, electronic tablets, and mobile devices. In addition, puzzles may be based on any useful mathematical question that may arise from an analysis of the specific rule which governs the puzzle or that may represent a mathematical interpretation of the puzzle and the rule which governs it.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

77. A mathematical learning device comprising:
(a) a plurality of puzzle grids, each said puzzle grid displaying at least one of four digit indicia, each of said digit indicia representing a number selected from the group consisting of the numbers 0, 1, 2, 3, 4, 5, 6, 7, 8, 9, all four said numbers of said digit indicia governed by a rule, in which said rule A, B, C, D are variables representing said numbers of said digit indicia, F, F′ are variables representing multipliers, W, W′, Y, Y′ are variables representing tens position numbers, X, X′, Z, Z′ are variables representing ones position numbers, each said number of each said variable is selected from the group consisting of the numbers 0, 1, 2, 3, 4, 5, 6, 7, 8, 9, the following statements are four mathematical equations relating said variables A, B, C to said variables representing said multipliers, said tens position numbers and said ones position numbers, namely,
FA=10W+X,
FC=10Y+Z,
F′A=10W′+X′,
F′B=10Y′+Z′,
and the following logical statement relating said variables B, C, D to said variables representing both said tens position numbers and said ones position numbers defines said rule in logical notation, namely,
(((B=W)&(D=Y))v((B=X)&(D=Z)))&(((C=W′)&(D=Y))v((C=X′)&(D=E))), and
(b) a plurality of solution grids, each said solution grid corresponding to one said puzzle grid and displaying at least one said digit indicium selected from the group consisting of said digit indicia and multiplier indicia representing said multipliers of same one said puzzle grid,
whereby the puzzle solver is able to learn how to reason more abstractly in relation to mathematical symbols through understanding said rule.

78. The mathematical learning device according to claim 1, wherein said four digit indicia are disposed in a grid pattern of two rows and two columns.

79. The mathematical learning device according to claim 1, wherein each said puzzle grid displays all four said digit indicia and whose corresponding said solution grid comprises said multiplier indicia.

80. The mathematical learning device according to claim 1, wherein each said puzzle grid displays all four said digit indicia and whose corresponding said solution grid comprises digit indicia, such that, with respect to each of one of four said digit indicia, all digit indicia, if each is substituted for said each of one of four said digit indicia in said rule, would be a valid substitute indicium according to said rule.

81. The mathematical learning device according to claim 1, wherein more than one said puzzle grid is displayed together, such that each displayed puzzle grid shares with at least one other said displayed puzzle grid at least one said digit indicium which is one and the same said digit indicium and shared by both.

82. The mathematical learning device according to claim 1, wherein at least one displayed said digit indicium is replaced by a variable indicium representing any said mathematical variable in said rule.

83. The mathematical learning device according to claim 4, wherein at least one displayed said digit indicium is replaced by a variable indicium representing any said mathematical variable in said rule.

84. A computer-implemented method of generating a list of puzzles for a mathematical learning device comprising:
initializing, in a memory, a set of four puzzle variables comprising: a first puzzle variable, a second puzzle variable, a third puzzle variable, and a fourth puzzle variable;
initializing, in the memory, a first unknown factor and a second unknown factor;
iterate, using a processor, each of the four puzzle variables in turn from 0 to 9;
for each iteration of each of the four puzzle variables, the processor:
iterates the first unknown factor from 0 to 9, calculates a first product of the first puzzle variable and the first unknown factor, calculates a second product of the third puzzle variable and the first unknown factor;
iterates the second unknown factor from 0 to 9, calculates a third product of the first puzzle variable and the second unknown factor, calculates a fourth product of the second puzzle variable and the second unknown factor;
if a tens position of the first product is equal to the second puzzle variable and a tens position of the second product is equal to the fourth puzzle variable, or a ones position of the first product is equal to the second puzzle variable and a ones position of the second product is equal to the fourth puzzle variable, and
a tens position of the third product is equal to the third puzzle variable and a tens position of the fourth product is equal to the fourth puzzle variable, or a ones position of the third product is equal to the third puzzle variable and a ones position of the fourth product is equal to the fourth puzzle variable,
then verify that the set of four puzzle variables is not part of the list of puzzles and add the set of four puzzle variables to the list of puzzles.

85. The computer-implemented method according to claim 8, further comprising:
for each of the set of four puzzle variables in the list of puzzles:
mask one of the four puzzle variables to produce a masked digit; and
generate a set of valid substitute values for the masked digit.
